(19) United States
(12) Patent Application Publication
(10) Pub. No.: US 2007/0142192 A1
(43) Pub. Date: Jun. 21, 2007

(54) Process for assembling a box

(76) Inventor: Mark Campbell, Newmarket (CA)

Correspondence Address: LANG MICHENER, BCE PLACE, P.O. BOX 747, SUITE 2500, 181 BAY STREET, TORONTO, ON, M5J 2T7, CA

(21) Appl. No.: 11/385,737

(22) Filed: Mar. 22, 2006

(30) Foreign Application Priority Data
Dec. 15, 2005 (CA) 2,530,339

(51) Int. Cl. B31B 1/62

(52) U.S. Cl. 493/131

(57) ABSTRACT

The invention consists of a method of making a container from a foldable pattern, comprising: a) placing one or more first contact glue spots on a first surface of the pattern; and b) placing one or more second contact glue spots on a second surface of the pattern, the second contact glue spots positioned in relation to the first contact glue spots such that when the pattern is folded to assemble the container, the first contact glue spots bond with the second contact glue spots to create a glued bottom for the container.

### FIELD OF THE INVENTION

The present invention relates to the field of assembling containers such as bags and boxes, with folded bottoms. In particular, it relates to a new method of reinforcing these folded bottoms by preparing specific surfaces on the fold patterns with contact glue prior to folding.

### BACKGROUND OF THE INVENTION

A longstanding method of creating and assembling boxboard cartons uses what is known as a Lockbottom carton. The Lockbottom carton consists of a die-cut pattern which is folded to create a box with a closed bottom. The box pattern can be automatically cut and shipped flat for later assembly at a destination. While the Lockbottom carton has proven very easy and reliable to make, it does suffer from a couple of deficiencies. First, the bottom is created strictly by folding, limiting the amount of weight that can be supported. Second, the Lockbottom carton pattern has not proven to be adaptable to other paper package processes, and in particular has been unsuitable for use in creating paper bags. As a result, the Lockbottom carton is typically used when the surface area on the bottom of the box is relatively small and the contents are reasonably lightweight.

Paper bags, in particular those used in retail sales and for decorative purposes (“gift bags”) used glued bottoms to increase the amount of weight that can be supported. The typical fold pattern used has proven difficult to automate and to date has been limited to lightweight paper stock and small size products, such as sugar bags and similar items. Therefore, the majority of paper bags are made by hand labor to create a bag of heavy paper stock and larger size.

There is clearly a need for a method of gluing Lockbottom cartons in order to increase the structure strength and allow for the use of Lockbottom cartons in a wider range of applications.

There is a further need for a method of folding and gluing larger paper bags that can be performed by automation rather than by hand.

Ideally, a suitable method is capable of fulfilling both these needs.

### SUMMARY OF THE INVENTION

According to an aspect of the invention, there is provided a method of making a container from a foldable pattern, comprising: a) placing one or more first contact glue spots or strips on a first surface of the pattern; and b) placing one or more second contact glue spots or strips on a second surface of the pattern, the second contact glue spots positioned in relation to the first contact glue spots such that when the pattern is folded to assemble the container, the first contact glue spots bond with the second contact glue spots to create a glued bottom for the container.

Preferably, the container is a bag or a box, and made of paper or cardboard.

Also, preferably, the number of first glue spots and second glue spots is equal. Additionally, the first glue spots may be arranged in a symmetric pattern when viewed as part of the glued bottom.

As an additional preferable feature, a sheet of material may be inserted into the completed container to reinforce the glued bottom. This reinforcing sheet may preferably include additional glue spots which correspond to glue spots on the glued bottom to secure the reinforcing sheet in place using the same bonding method as the glued bottom.

Optionally, additional glue spots may be included in additional fold locations on the pattern to provide glued edges for the container.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a top view of one side of a Lockbottom carton style bag pattern;

FIG. 2 is a top view of the opposite said of the bag pattern of FIG. 1; and

FIG. 3 is a bottom view of a bag made from the pattern of FIG. 1.

### DETAILED DESCRIPTION OF THE PREFERRED EMBODIMENTS

Within this specification, “container” means a bag, box, or similar receptacle product that is formed from a foldable pattern which has been cut and marked on a sheet of material. Furthermore, the folded and glued surface is referred to as the “bottom” of the container by convention, but may represent any or one or more surfaces in any orientation in the final product.

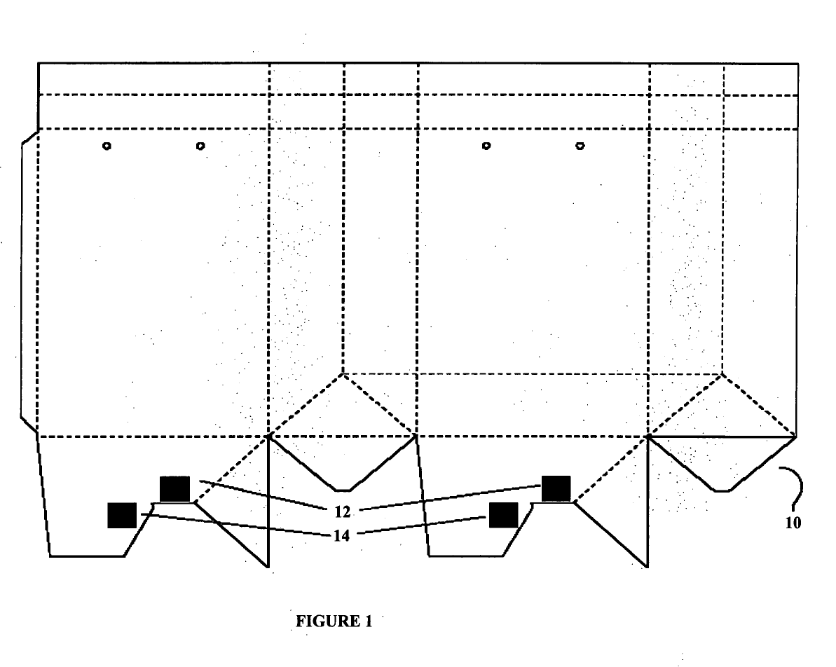

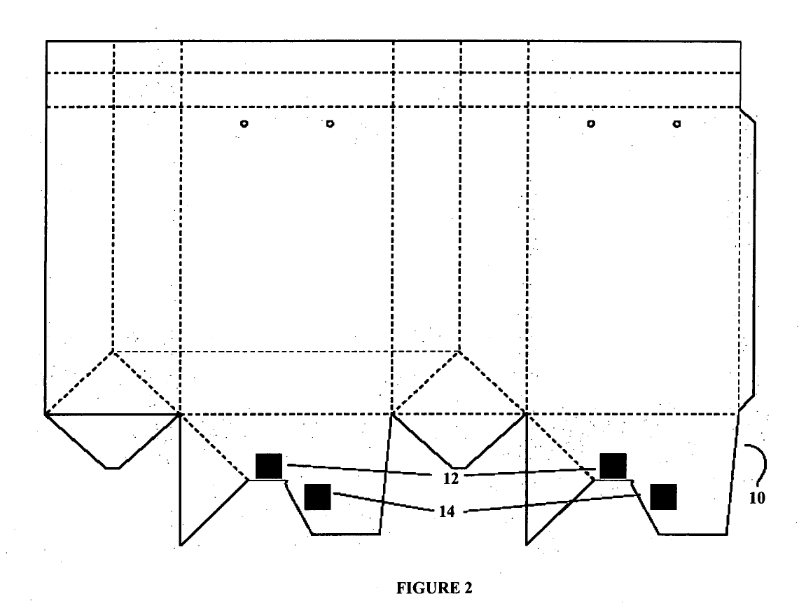

Referring to FIG. 1, a die-cut foldable Lockbottom carton pattern for a paper bag is indicated by reference numeral 10. Crease lines for folding the pattern into a bag are shown as dashed lines in FIG. 1. Located at foldover locations for the bottom of the bag are contact glue spots 12. Additional contact glue spots 14 are located on the opposite side of the pattern 10. FIG. 2 shows the opposite face of pattern 10, with glue spots 12 and 14 as indicated. While two corresponding pairs of glue spots (one from 12 and one from 14) are shown, the number of glue spots 12 and 14 may be adjusted to reflect the dimensions and materials used for the container. Similarly, the size and shape of glue spots 12 and 14 can be varied to determine the optimal values for a container of a specific size and material.

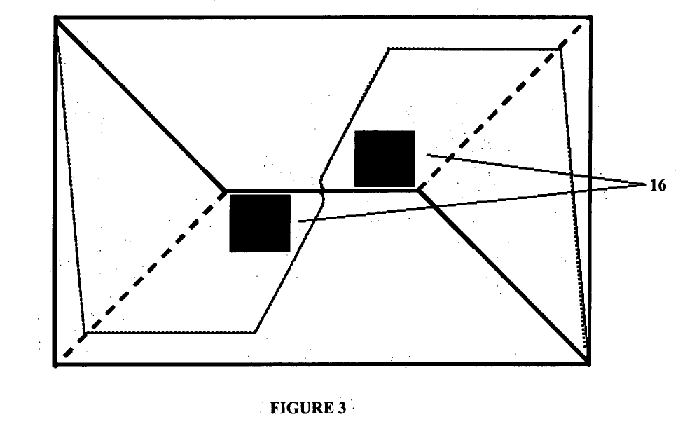

When the pattern is folded into a bag, glue spots 12 and glue spots 14 come into contact, as shown in FIG. 3, and the contact glue used for glue spots 12 and 14 is activated by this contact to secure the bottom foldover locations with glued points indicated at 16. The result is that the finished bag has a glued bottom as shown in FIG. 3. In FIG. 3, dashed lines are used to show the interior pattern of the folded pieces for greater clarity.

The contact glue used for glue spots 12 and 14 is of a type where the contact glue is activated upon applied pressure when in contact with another glue spot. The glue does not activate on contact with the paper or other material used for the container, allowing the containers to be shipped flat and later folded at their destination, in accordance with current practice. Also, the glue spots may be applied by appropriate machinery in the course of cutting and marking the container pattern, without concerns about premature activation of the glue interfering with the process.

While the pattern 10 shown is for a bag, it can be readily seen that the same principle applies for making any Lockbottom carton box or any other container from a foldable pattern.

Also, while not explicitly shown in the drawings, any additional edges, surfaces or seams can be secured by using additional glue spots in suitable locations on the pattern as required.

It is additionally noted that the incomplete contact and fusion of the glue spots 12 and 14 is generally not a concern, as once the assembled container is put into use and pressure is applied to the bottom, any non-contacting glue spots 12 and 14 will be forced into contact and activated.

It can be readily seen that the glued bottom is stronger than the mere folded bottom of the prior art. Furthermore, the addition of the glue spots 12 and 14 to existing die-cut patterns can be readily accomplished through modifications of existing automated machinery. The end result is a bag that can be produced with the elimination of a substantial portion, if not all, of the hand labor requirements of the prior art bags. For boxes, existing Lockbottom cartons can be made of thinner materials, reducing weight and cost.

Also, as many of these types of containers, particularly the bags, have printed or applied images to the surfaces, it is further noted that the glue spots may be applied either before or after the printing/application process.

If desired, additional strength for the bottom may be provided by inserting an additional piece of heavy cardstock, cardboard, thin plastic or a similar material into the container bottom after assembly. Glue spots on this additional piece and on the interior bottom surfaces may be used to secure this additional piece in place.

While traditionally the containers have been made from paper or cardboard, advances in modern materials technology have created the possibility of making containers from other lightweight, resilient and foldable materials, such as metallic films and thin plastics. The folding and gluing process claimed herein is considered generally applicable to any of these materials, although it is acknowledged that in some instances the process may be inferior to other methods or generally unsuitable. Each material and method may require testing to determine optimal size and location for the glue spots, and possible the type and strength of contact glue, as described above.

This concludes the description of a presently preferred embodiment of the invention. The foregoing description has been presented for the purpose of illustration and is not intended to be exhaustive or to limit the invention to the precise form disclosed. Many modifications and variations are possible in light of the above teaching and will be apparent to those skilled in the art. It is intended the scope of the invention be limited not by this description but by the claims that follow.

What is claimed is:

1. A method of making a container from a foldable pattern, comprising:
a) placing one or more first contact glue spots on a first surface of said pattern; and
b) placing one or more second contact glue spots on a second surface of said pattern, said second contact glue spots positioned in relation to said first contact glue spots such that when said pattern is folded to assemble said container, said first contact glue spots bond with said second contact glue spots to create a glued bottom for said container.

2. The method according to claim 1, wherein said container is a bag.

3. The method according to claim 1, wherein said container is a box.

4. The method according to claim 3, wherein said box is made from cardboard.

5. The method according to claim 1, wherein said first self-sealing glue spots and said second self-sealing glue spots are equal in number.

6. The method according to claim 1, wherein said first self-sealing glue spots are positioned such that said first self-sealing glue spots form a symmetric pattern when viewed on said glued bottom of said container.

7. The method according to claim 1, further including placing additional glue spots on said foldable pattern which contact each other upon assembly of said container to create one or more glued edges for said container.

8. The method according to claim 1, further including an additional step of inserting a sheet of material into said container to reinforce said glued bottom.

9. The method according to claim 8, further including placing one or more glue spots on said sheet of material and placing corresponding glue spots on interior surfaces of said bottom to secure said sheet of material when said one or more glue spots are contacted with said corresponding glue spots.
